(19) United States
(12) Patent Application Publication
(10) Pub. No.: US 2019/0293080 A1
(43) Pub. Date: Sep. 26, 2019

(54) TURBO COMPRESSOR

(71) Applicant: MAN Energy Solutions SE, Augsburg (DE)

(72) Inventors: Jirí Klíma, Namest nad Oslavou (CZ); Klaus Bartholomä, Friedberg (DE); Ondrej Tomek, Namest nad Oslavou (CZ)

(21) Appl. No.: 16/362,295

(22) Filed: Mar. 22, 2019

(30) Foreign Application Priority Data
Mar. 23, 2018 (DE) DE102018106944.8

(51) Int. Cl. F04D 29/056; F04D 29/063; F02B 33/34

(52) U.S. Cl. CPC F04D 29/056; F04D 25/06; F02B 33/34; F04D 29/063

(57) ABSTRACT

A turbo compressor, with a shaft mounted in a housing to drive a compressor rotor and an electric motor, which drives the shaft. Bearings, via which the shaft is mounted in the housing, are designed as sliding bearings.

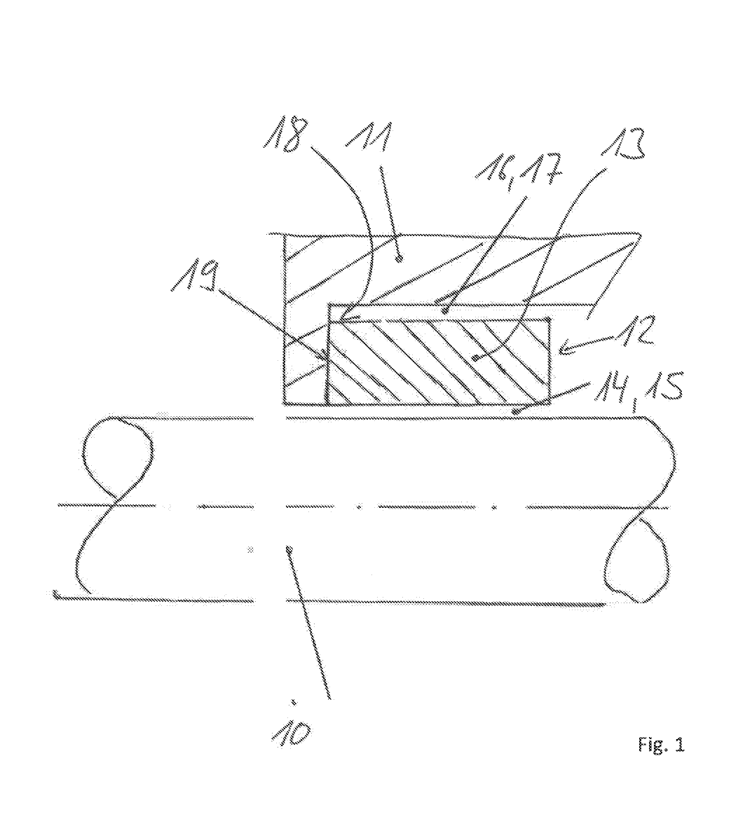

### BACKGROUND OF THE INVENTION

### 1. Field of the Invention

The invention relates to a turbo compressor.

### 2. Description of the Related Art

Internal combustion engines with exhaust gas recirculation are familiar to the person skilled in the art addressed here. In such internal combustion engines it is known to extract exhaust gas, which leaves the internal combustion engine from an exhaust gas branch of the internal combustion engine and conduct it via a so-called exhaust gas recirculation blower of the exhaust gas recirculation, which is also referred to as EGR blower, in the direction of a charge air tract of the internal combustion engine and then mix the exhaust gas with the charge air to be fed to the cylinders of the internal combustion engine.

Exhaust gas recirculation blowers or EGR blowers are typically embodied as turbo compressors that compress the exhaust gas to a defined pressure. For this purpose, a turbo compressor of an exhaust gas recirculation of an internal combustion engine comprises at least one compressor stage, wherein the or each compressor stage, namely a rotor of the same, can be driven via a shaft that is mounted in a housing of the turbo compressor. Here, an electric motor assumes the driving of the shaft and, via the shaft, the driving of the or each compressor rotor of the or each compressor stage.

Turbo compressors of an exhaust gas recirculation of an internal combustion engine known from practice utilise rolling bearings to mount the shaft, which is driven emanating from the electric motor and which serves for driving the or each compressor rotor, in the housing. Such rolling bearings have an inner bearing race, an outer bearing race and rolling bodies positioned between the inner bearing race and the outer bearing race.

### SUMMARY OF THE INVENTION

One aspect of the present invention is a new type of turbo compressor. According to one aspect of the invention, bearings, via which the shaft is mounted in the housing, are formed as sliding bearings. With the invention present here it is proposed for the first time to mount the shaft of a turbo compressor in the housing via sliding bearings. By way of this, a more compact design can be ensured. Furthermore, an advantageous damping effect can be provided for the shaft. It is possible, furthermore, to operate the turbo compressor in the range of its natural frequency.

According to an advantageous further development, a radially outer damping oil film is formed between a bearing ring of the sliding bearing and the housing. Between the bearing ring of the sliding bearing and the shaft, a radially inner load transmission and damping oil film is formed furthermore. By way of this, an optimal damping and an optimal load transmission are made possible.

According to an advantageous further development, the bearing ring of the sliding bearing is arranged in a recess in the housing, wherein the bearing ring of the sliding bearing exclusively supports itself at an axial end of the housing. This also serves for providing an optimal damping and load transmission.

According to an advantageous further development, the electric motor drives the shaft with a rotational speed between 10,000 revolutions per minute and 50,000 revolutions per minutes. With such fast-running shafts of turbo compressors of an exhaust gas recirculation, the invention can be particularly advantageously employed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

The Figure is an axial section through a detail of a turbo compressor.

### DETAILED DESCRIPTION OF THE PRESENTLY PREFERRED EMBODIMENTS

The invention relates to a turbo compressor.

The invention, in particular, relates to a turbo compressor of an exhaust gas recirculation of an internal combustion engine. Such a turbo compressor serves for conveying and compressing exhaust gas which is extracted from an exhaust gas tract of an internal combustion engine and conveyed in the direction of a charge air tract of the internal combustion engine with the help of the turbo compressor.

A turbo compressor comprises a housing 11 with a shaft 10 mounted in a housing 11. The shaft 10 is driveable emanating from an electric motor M. The shaft 10 serves for driving at least one compressor rotor of at least one compressor stage of the turbo compressor. The turbo compressor can comprise multiple compressor stages each with a compressor rotor, wherein the shaft 10 then drives all compressor rotors.

The Figure shows an extract from the shaft 10 together with a section of the housing 11 of the turbo compressor.

In terms of the invention present here it is proposed that the shaft 10 is mounted in the housing 11 via bearings designed as sliding bearings 12.

Such a sliding bearing 12 has a single bearing ring 13. Between the bearing ring 13 and the shaft 10 a radially inner gap 14 is formed, in which an inner load transmission and damping oil film 15 can form.

Between the bearing ring 13 of the sliding bearing 12 and the housing 11, a radially outer gap 16 is formed, in which a radially outer damping oil film 17 can form.

The radially outer damping oil film 17 in the gap 16 between the bearing ring 13 of the sliding bearing 12 and the housing 11 serves exclusively for providing a damping effect via a corresponding squeeze oil film 17.

The load transmission and damping oil film 15 between the bearing ring 13 of the sliding bearing 12 and the shaft 10 additionally serves for providing a damping effect of the load transmission.

The bearing ring 13 of the sliding bearing 12 is positioned in a recess 18 of the housing 11. From the Figure it is evident that the bearing ring 12 supports itself on the housing 11 of the turbo compressor at an axial end 19.

The shaft 10 of the turbo compressor of the exhaust gas recirculation is driven by the electric motor preferentially with a rotational speed between 10,000 revolutions per minute (rpm) and 50,000 revolutions per minute (rpm). With such fast-running shafts 10, the sliding bearing mounting of the turbo compressor is particularly favourably employed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbo compressor, comprising:
a housing;
a shaft mounted in the housing and configured to drive a compressor rotor;
an drive configured to drive the shaft; and
sliding bearings configured to mount the shaft in the housing.

2. The turbo compressor according to claim 1, wherein a radially outer damping oil film is formed between a bearing ring of the sliding bearing and the housing.

3. The turbo compressor according to claim 1, wherein a radially inner load transmission and damping oil film is formed between a bearing ring of the sliding bearing and the shaft.

4. The turbo compressor according to claim 1, wherein
a bearing ring of the sliding bearing is arranged in a recess in the housing, and
the bearing ring of the sliding bearing supports itself exclusively on an axial end of the housing.

5. The turbo compressor according to claim 1, wherein the drive is configured to drive the shaft with a rotational speed between 10,000 and 50,000 revolutions per minute.

6. The turbo compressor according to claim 1, wherein the turbo compressor is a turbo compressor of an exhaust gas recirculation.

7. The turbo compressor according to claim 2, wherein a radially inner load transmission and damping oil film is formed between the bearing ring and the shaft.

8. The turbo compressor according to claim 1, wherein the drive is an electric motor.

9. The turbo compressor according to claim 8, wherein the electric motor is configured to drive the shaft with a rotational speed between 10,000 and 50,000 revolutions per minute.
